(19) United States
(12) Patent Application Publication
(10) Pub. No.: US 2024/0316647 A1
(43) Pub. Date: Sep. 26, 2024

(54) ADDITIVE MANUFACTURING SYSTEM WITH PARTIALLY FLEXIBLE BUILD PLATFORM

(71) Applicant: GE Infrastructure Technology LLC, Greenville, SC (US)

(72) Inventors: Yang JIAO, Niskayuna, NY (US); Sreekar KARNATI, Niskayuna, NY (US); Changjie SUN, Niskayuna, NY (US); Anthony POLI, Jr., Niskayuna, NY (US); John Matthew SASSATELLI, Schenectady, NY (US); Archie Lee SWANNER, Jr., Greenville, SC (US)

(21) Appl. No.: 18/578,197

(22) PCT Filed: Jul. 15, 2022
(86) PCT No.: PCT/US2022/037274

§ 371 Date: Jan. 10, 2024

Related U.S. Application Data
(63) Continuation of application No. 17/376,291, filed on Jul. 15, 2021.

(51) Int. Cl. B22F 12/30; B22F 10/28; B33Y 30/00

(52) U.S. Cl. CPC B22F 12/30; B33Y 30/00; B22F 10/28

(57) ABSTRACT

An additive manufacturing (AM) system, comprises an adjustable base; a build platform including a peripheral region and a periphery of the peripheral region, the periphery being fixedly and rigidly coupled to the base and a middle region, wherein a metallurgical connection fixedly and rigidly couples the periphery of the peripheral region to the base; and a build material applicator for depositing a build material above the build platform for creating an object.

### GOVERNMENT CONTRACT RIGHTS

This invention was made with Government support under Department of Energy Contract No. C#2560611001. The Government has certain rights in the invention.

### TECHNICAL FIELD

The disclosure relates generally to additive manufacturing, and more particularly, to an additive manufacturing system having a partially flexible build platform.

### BACKGROUND

Additive manufacturing (AM) includes a wide variety of processes of producing an object through the successive layering of material on a build platform rather than the removal of material from a block of material. With certain additive manufacturing processes, as the object is built, it can apply a stress to the build platform. For example, in a selective laser melting (SLM) AM process, large parts with large weld areas compared to the build platform area can cause the build platform to deform or warp due to thermal shrinkage. Where the build platform is fully rigidly constrained to the base of the AM system, the thermal stress can remain in the part, causing defects. Alternatively, the stress can damage the connection between the build platform and the base. One corrective approach adds compliant supports to the object that are allowed to deform, but the supports can be expensive and time consuming to build and complicate the manufacture of the object. Other approaches implement complicated spring systems between the base and the build platform, allowing the entire build platform to flex. The spring systems can clog from material accumulation therein, and disadvantageously may require independent movement of the base relative to the build platform.

### BRIEF DESCRIPTION

All aspects, examples and features mentioned below can be combined in any technically possible way.

An aspect of the disclosure provides an additive manufacturing (AM) system, comprising an adjustable base; a build platform including a periphery and peripheral region fixedly and rigidly coupled to the base and a middle region; wherein a metallurgical connection fixedly and rigidly couples the periphery of the build platform to the base; and a build material applicator for depositing a build material above the build platform for creating the object.

Another aspect of the disclosure includes any of the preceding aspects, and the metallurgical connection includes at least one of a weld, solder, braze, or solid-state connection for fixedly and rigidly coupling the periphery of the peripheral middle region to the base.

Another aspect of the disclosure includes any of the preceding aspects, and the metallurgical connection includes at least one weld for fixedly and rigidly coupling the periphery of the peripheral region to the base.

Another aspect of the disclosure includes any of the preceding aspects, and the at least one weld includes at least one of a fusion weld, a tack weld, a metal inert gas (MIG) weld, a gas metal arc weld (GMAW), a tungsten inert gas (TIG) weld, a gas tungsten arc weld (GTAW), a stick-shielded metal arc weld (SMAW), a flux-cored-flux weld, an energy beam weld (EBW), an atomic hydrogen weld (AHW), a plasma arc weld, and combinations thereof for fixedly and rigidly coupling the periphery of the peripheral region to the base.

Another aspect of the disclosure includes any of the preceding aspects, and the at least one weld includes a tack weld.

Another aspect of the disclosure includes any of the preceding aspects, and the metallurgical connection is provided by the build material applicator for fixedly and rigidly coupling the periphery of the peripheral region to the base.

Another aspect of the disclosure includes any of the preceding aspects, and the metallurgical connection includes the build material for fixedly and rigidly coupling the periphery of the peripheral region to the base.

Another aspect of the disclosure includes any of the preceding aspects, and the base is formed from a first material and the metallurgical connection includes the first material.

Another aspect of the disclosure includes any of the preceding aspects, and the base directly contacts the build platform.

Another aspect of the disclosure includes any of the preceding aspects, and the build material applicator for depositing a build material that deposits build material by at least one of direct metal laser melting; direct metal laser sintering; selective laser melting; and directed energy deposition.

Another aspect of the disclosure includes any of the preceding aspects, and the periphery of the peripheral region includes first opposing peripheries across an X axis of the build platform and second opposing peripheries across a Y axis of the build platform, and the metallurgical connection is positioned on at least one of the X axis and the Y axis.

Another aspect of the disclosure includes any of the preceding aspects, and the metallurgical connection is positioned on the X axis and the Y axis.

An aspect of the disclosure provides an additive manufacturing (AM) system, comprising an adjustable base; a build platform including a middle region and a peripheral region including a periphery, the periphery of the peripheral region fixedly and rigidly coupled to the base by a metallurgical connection configured for fixedly and rigidly coupling the periphery of the peripheral region to the base; and a build material applicator for depositing a build material above the build platform for creating the object.

Another aspect of the disclosure includes any of the preceding aspects, and the metallurgical connection includes at least one of a weld, solder, braze, or solid-state connection for fixedly and rigidly coupling the periphery of the peripheral region to the base.

Another aspect of the disclosure includes any of the preceding aspects, and the metallurgical connection includes at least one weld for fixedly and rigidly coupling the periphery of the peripheral region to the base.

Another aspect of the disclosure includes any of the preceding aspects, and the at least one weld includes at least one of a fusion weld, a tack weld, a metal inert gas (MIG) weld, a gas metal arc weld (GMAW), a tungsten inert gas (TIG) weld, a stick-shielded metal arc weld (SMAW), a flux-cored-flux weld, an energy beam weld (EBW), an atomic hydrogen weld (AHW), and a plasma arc weld for fixedly and rigidly coupling the periphery of the peripheral region to the base.

Another aspect of the disclosure includes any of the preceding aspects, and the at least one weld includes a tack weld.

Another aspect of the disclosure includes any of the preceding aspects, and the metallurgical connection is provided by the build material applicator for fixedly and rigidly coupling the periphery of the peripheral region to the base.

Another aspect of the disclosure includes any of the preceding aspects, and the metallurgical connection includes the build material for fixedly and rigidly coupling the periphery of the peripheral region to the base.

Another aspect of the disclosure includes any of the preceding aspects, and the base is formed from a first material and the metallurgical connection includes the first material.

Another aspect of the disclosure includes any of the preceding aspects, and wherein the peripheral region includes first opposing peripheries across an X axis of the build platform and a second opposing peripheries across a Y axis of the build platform, and the metallurgical connection is positioned on at least one of the X axis and the Y axis.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 illustrates a cross-sectional view of an additive manufacturing (AM) system including a partially flexible build platform in a non-flexed state, according to embodiments of the disclosure;

FIG. 2 illustrates a plan view of an AM system including a partially flexible build platform, according to embodiments of the disclosure;

FIG. 3 illustrates a plan view of an additive manufacturing (AM) system including a partially flexible build platform, according to other embodiments of the disclosure;

FIG. 4 illustrates a plan view of an AM system including a partially flexible build platform, according to further embodiments of the disclosure;

FIG. 5 illustrates a plan view of an AM system including a partially flexible build platform, according to further embodiments of the disclosure;

FIG. 6 illustrates a block diagram of a rectangular additively manufactured object on a build platform and base with a metallurgical connection between the build platform and base, according to embodiments of the disclosure;

FIG. 7 illustrates a block diagram of an AM system and method, according to embodiments of the disclosure;

FIGS. 8A and 8B illustrate schematic views of a front view and a top view of separation restrictor(s), according to more embodiments of the disclosure;

FIG. 9 illustrates a schematic front view of an alternate embodiment of the flexible base that includes at least one slot in the AM system base, according to embodiments of the disclosure;

FIG. 10 illustrates a schematic front view of an additional alternate embodiment of the flexible base that includes reduced interface area between the object being built and the AM system base, according to embodiments of the disclosure;

FIG. 11 illustrates an alternate embodiment of the flexible base with an object built by the AM system including a reduced area connection at the object being built and base, according to embodiments of the disclosure;

FIG. 12 illustrates a block diagram of an additional alternate embodiment of the flexible base with a rectangular additively manufactured object on a build platform and base with an elongated metallurgical connection between the build platform and base, according to embodiments of the disclosure;

FIG. 13 illustrates a further block diagram of an additional alternate embodiment of the flexible base with a rectangular additively manufactured object on a build platform and base with a metallurgical connection disposed beneath and between the build platform and base, according to embodiments of the disclosure; and

FIG. 14 illustrates a block diagram of an additional alternate embodiment of the flexible base with a rectangular additively manufactured object on a build platform and base with a metallurgical connection between the build platform and base, according to embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the subject matter of the current disclosure, it will become necessary to select certain terminology when referring to and describing relevant machine objects within an additive manufacturing system. To the extent possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular object may be referred to using several different or overlapping terms. What may be described herein as being a single part may include and be referenced in another context as consisting of multiple parts. Alternatively, what may be described herein as including multiple parts may be referred to elsewhere as a single part.

Several descriptive terms may be used regularly herein, as described below. The terms “first,” “second,” and “third” may be used interchangeably to distinguish one object from another and are not intended to signify location or importance of the individual objects.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or objects but do not preclude the presence or addition of one or more other features, integers, steps, operations, elements, objects, and/or groups thereof. “Optional” or “optionally” means that the subsequently described event or circumstance may or may not occur or that the subsequently described object or element may or may not be present, and that the description includes instances where the event occurs, or the object is present and instances where it does not or is not present.

Where an element or layer is referred to as being “on,” “engaged to,” “connected to” or “coupled to” another element or layer, it may be directly on, engaged to, connected to, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As indicated above, the disclosure provides an additive manufacturing (AM) system that includes a partially flexible build platform. More particularly, the AM system can include a build chamber (especially for those additive manufacturing processes where a controlled environment is desired), a base adjustably (coupled to the build chamber if provided), and a build material applicator for depositing a build material above a build platform for creating the object. That is, the peripheral region(s), e.g., one or more outer section(s) of the build platform are given flexibility to flex or curl up as the object(s) cool and “pull” on the build platform. The partial flexibility allows deformation caused by thermal distortion of the build platform during the print process to reduce final object stress. With a less restrictive build platform, stress can be reduced in at least the lower portion of the object, reducing risk of stress induced defects. The AM system can thus produce larger additively manufactured objects out of crack-prone material. In addition, the partial flexibility may prevent damage to the build platform and/or base without an overly complicated arrangement.

Embodiments of the disclosure can be applied to any type of additive manufacturing system. Additive manufacturing techniques typically include taking a three-dimensional computer aided design (CAD) file of the object to be formed, electronically slicing the object into layers, e.g., 18-102 micrometers thick, and creating a file with a two-dimensional image of each layer, including vectors, images, or coordinates. The file may then be loaded into a preparation software system that interprets the file such that the object can be built by different types of additive manufacturing systems.

In 3D printing, directed energy deposition (DED) technology involves using a focused heat source, such as but not limited to, a laser, electron beam or a gas-tungsten arc to create a melt pool and add filler material(s) in powder or wire form into the melt pool. The DED process may follow a toolpath created directly from CAD geometry and builds up parts in successive layers. In certain aspects of the embodiments, DED can direct energy into cramped and focused areas to simultaneously heat a substrate and melt material and a substrate. Every path of a DED head can form a track from solidified materials, and the layers can be created by contiguous material lines.

In 3D printing, rapid prototyping (RP), and direct digital manufacturing (DDM) forms of additive manufacturing, material layers are selectively dispensed, sintered, formed, deposited, etc., to create the object. In metal powder additive manufacturing techniques, such as direct metal laser melting (DMLM) (also referred to as selective laser melting (SLM)), metal powder layers are sequentially melted together to form the object. More specifically, fine metal powder layers are sequentially melted after being uniformly distributed using an applicator on a build platform in the form of metal powder bed.

Alternately, and in addition to, additive manufacturing processes and systems include, for example, and without limitation, vat photopolymerization, powder bed fusion, binder jetting, material jetting, sheet lamination, material extrusion, directed energy deposition and hybrid systems. These processes and systems include, for example, and without limitation: stereolithography apparatus (SLA); digital light processing (DLP); scan, spin, and selectively photocure (3SP); liquid interface production (CLIP); selective laser sintering (SLS); direct metal laser melting (DMLM); or direct metal laser sintering (DMLS); selective laser melting (SLM); electron beam melting (EBM); selective heat sintering (SHS); multi-jet fusion (MJF); 3D printing, voxeljet, polyjet; smooth curvatures printing (SCP); multi-jet modeling projet (MJM); laminated object manufacture (LOM); selective deposition lamination (SDL); ultrasonic additive manufacturing (UAM); fused filament fabrication (FFF); fused deposition modeling (FDM); laser metal deposition (LMD); laser engineered net shaping (LENS); direct metal deposition (DMD); hybrid systems; combinations of these processes and systems; and other additive manufacturing systems and processes now known or hereinafter developed. These processes and systems may employ, for example, and without limitation, all forms of electromagnetic radiation, heating, sintering, melting, curing, binding, consolidating, pressing, embedding, and combinations thereof.

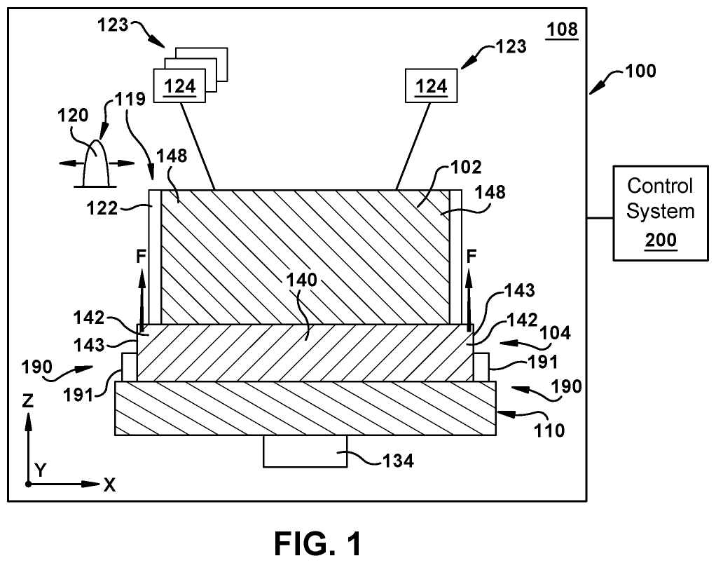

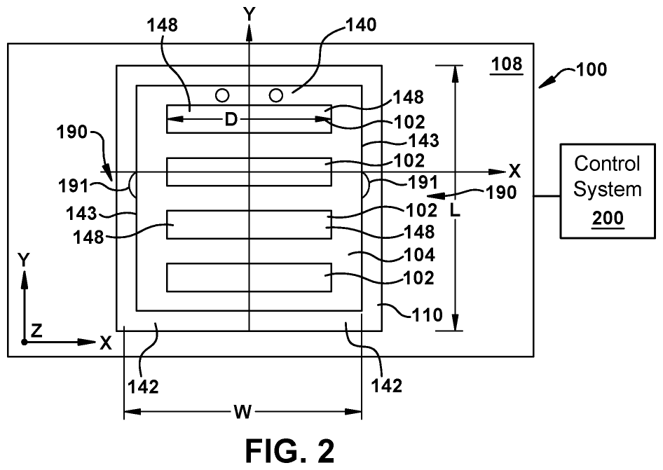

FIG. 1 illustrates a schematic cross-sectional view and FIG. 2 illustrates a plan view of an additive manufacturing system 100 for building one or more objects 102. For purposes of description, an additive manufacturing system 100, such as, but not limited to a DED additive manufacturing system (hereinafter ‘AM system 100’) in the form of computerized metal powder additive manufacturing system will be referenced.

With reference to FIGS. 1 and 2, AM system 100 is creating object(s) 102 on an intermediate plate or build platform 104 (hereinafter “build platform 104”). AM system 100 can generate an object 102, which may include one large object or multiple objects 102 of which only a single layer is shown in FIG. 2. Object(s) 102 are illustrated as rectangular elements; however, it is understood that the additive manufacturing process can be readily adapted to manufacture any shaped object, a large variety of objects and a large number of objects on a build platform 104.

In any event, AM system 100 can include a build chamber 108 (especially for those additive manufacturing processes where a controlled environment is desired), a base adjustably, and a base 110 adjustably coupled to build chamber 108 (if a build chamber is provided). Build chamber 108, if provided, can be arranged such that a Y-direction and an X-direction are substantially coplanar with build platform 104 and base 110, and a Z-direction is substantially perpendicular to build platform 104 and base 110. Build chamber 108 can provide a controlled atmosphere for object(s) 102 printing, e.g., a set pressure and temperature for lasers, or a vacuum for electron beam melting.

AM system 100 may include a build material depositing system 119 for depositing build material 122 above build platform 104 for creating object(s) 102. Build material depositing system 119 may include any now known or later developed material delivery system. For the example of a directed energy deposition (DED) system, system 119 may include a build material applicator or build material applicator head 120 (“applicator 120”) for depositing build material 122 above build platform 104 for creating object(s) 102. In metal powder applications, applicator 120 deposits a layer of material 122, i.e., over an underlying layer of object(s) 102. Applicator 120 delivers and smooths the new layers of metal powder build material 122 (FIG. 1).

Once a layer is formed, a welding system 123 welds a portion of the layer of material 122. In the example AM system 100, welding system 123 includes high powered melting beam(s), such as a 100-Watt ytterbium laser(s) 124, which can melt or sinter a portion of the layer of build material 122, which later solidifies to form object(s) 102. Laser(s) 124 and/or build platform 104 moves in the X-Y direction. Once a layer of object(s) 102 has been formed, base 110 is lowered by a vertical adjustment system 134. Vertical adjustment system 134 may also vertically adjust a position of other parts of AM system 100 to accommodate the addition of each new layer. For example, a build platform 104 may lower and/or build chamber 108 and/or applicator 120 may rise after each layer is formed.

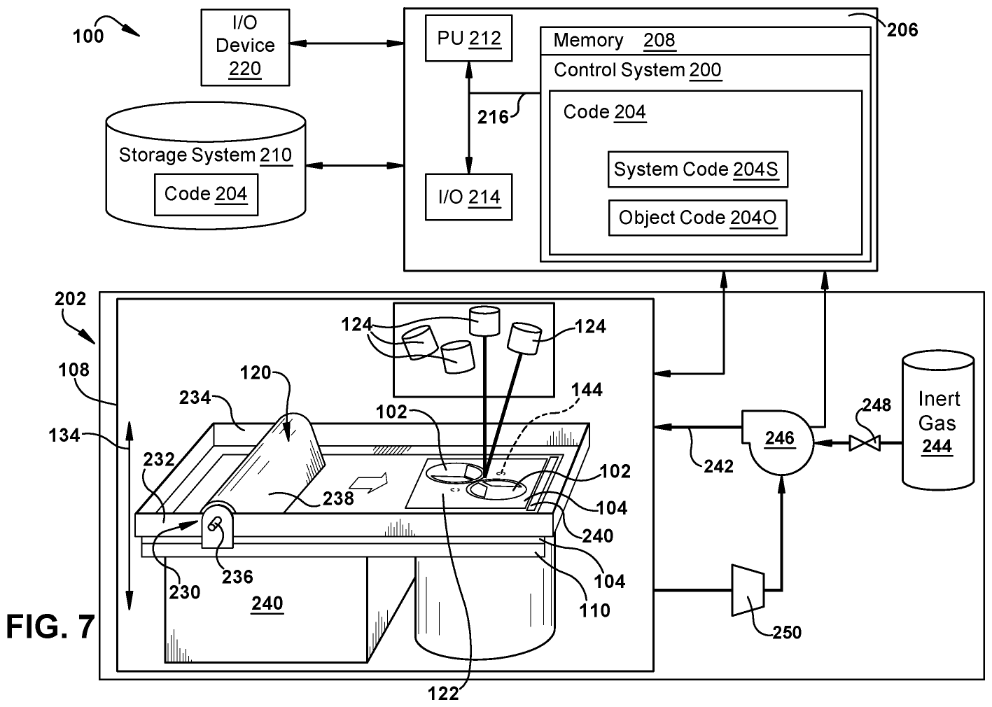

An adjustment system 134, such as but not limited to a vertical adjustment system, a horizontal adjustment system, a combined vertical and horizontal adjustment system, and/or combined vertical and horizontal adjustment system with rotation capability, may include any now known or later developed linear actuators to provide such adjustment that are under the control of an AM control system 200 (FIG. 7), described elsewhere herein. Adjustment system 134 may be provided in additive manufacturing systems as needed, however additive manufacturing systems including DED may not benefit from an adjustment system 134, as described herein. Once lowered, the process is then repeated, starting with applicator 120 directing a layer of build material 122 across the now-lower object(s) 102. Build platform 104 on base 110 may be lowered for each subsequent two-dimensional layer, and the process repeats until object(s) 102 is completely formed.

During formation, thermal stress may be created in object(s) 102 during the build, which may be retained in object(s) 102 and/or applied to build platform 104. In accordance with embodiments of the disclosure, build platform 104 includes a middle region 140, and a periphery 143 of a peripheral region 142 fixedly and rigidly coupled to base 110. Retained stress may cause undesirable flexing of build platform 104, including flexing of a periphery 143 of a peripheral region 142 of build platform 104. FIG. 1 shows object 102 and build platform 104 before preventing flexing, as embodied by the disclosure. Build platform 104 may be adjustably coupled to base 110.

Build platform 104 may be coupled to base 110, for example, by at least one flex or separation restrictor (hereinafter “separation restrictor”) to prevent periphery 143 of peripheral region 142 from flexing or separating away from base 110. In one aspect as embodied by the disclosure, the at least one separation restrictor includes a metallurgical connection 190 or weld 191.

In certain aspects of the embodiments, metallurgical connection 190 includes at least one of a weld 191, solder, braze, or solid-state connection for fixedly and rigidly coupling periphery 143 of peripheral region 142 to base 110. Alternatively, or in addition thereto, the metallurgical connection 190 includes at least one weld 191 for fixedly and rigidly coupling periphery 143 of peripheral region 142 to base 110. In certain aspects of the embodiments, the at least one weld 191 can be positioned at periphery 143 of peripheral region 142 of build platform 104 and extend onto base 110. Thus, as embodied by the disclosure, the metallurgical connection, such as the at least one weld 191, can fixedly and rigidly coupling build platform 104 to base 110 fixed at periphery 143 of peripheral region 142. Hence, build platform 104 is always in direct contact with base 110 at periphery 143 of peripheral region 142. Thus, periphery 143 of peripheral region 142 cannot move entirely independently of base 110.

In accordance with certain aspects of the disclosure, the metallurgical connection may include the at least one weld 191. Each at least one weld 191 may include at least one of a fusion weld, a tack weld, a metal inert gas (MIG) weld, a gas metal arc weld (GMAW), a tungsten inert gas (TIG) weld, a gas tungsten arc weld (GTAW), a stick-shielded metal arc weld (SMAW), a flux-cored-flux weld, an energy beam weld (EBW), an atomic hydrogen weld (AHW), a plasma arc weld, and combinations thereof for fixedly and rigidly coupling build platform 104 to base 110 fixed at periphery 143 of peripheral region 142. Moreover, as embodied by the disclosure, the metallurgical connection 190 may include combinations of welds 191, as well as any weld now known or hereafter developed.

In a further aspect of the disclosure the metallurgical connection 190 is a tack weld 191. At least one weld, such as but not limited to a tack weld 191, can be fixed at at least one side or periphery (hereinafter “periphery”) 143 of peripheral region 142. Alternatively, or in addition thereto, a tack weld 191 can be fixed at more than one periphery 143 of peripheral region 142. As embodied by the disclosure, one or more welds 191 can be fixed at each periphery 143 of peripheral region 142.

The metallurgical connection, such as but not limited to weld 191, can be provided by the build material applicator 120 for fixedly and rigidly coupling build platform 104 to base 110 fixed at periphery 143 of peripheral region 142. In this case, AM system 100 can provide object code 204O to have applicator 120 form metallurgical connection 190 between base 110 and build platform 104, i.e., as part of object 102.

In an additional aspect as embodied by the disclosure, metallurgical connection 190 can include build material 122 for fixedly and rigidly coupling build platform 104 to base 110 fixed at periphery 143 of peripheral region 142. Further, in another aspect of the disclosure, base 110 can be formed from a first material, and the metallurgical connection 190, which may be at least one weld 191, includes the first material.

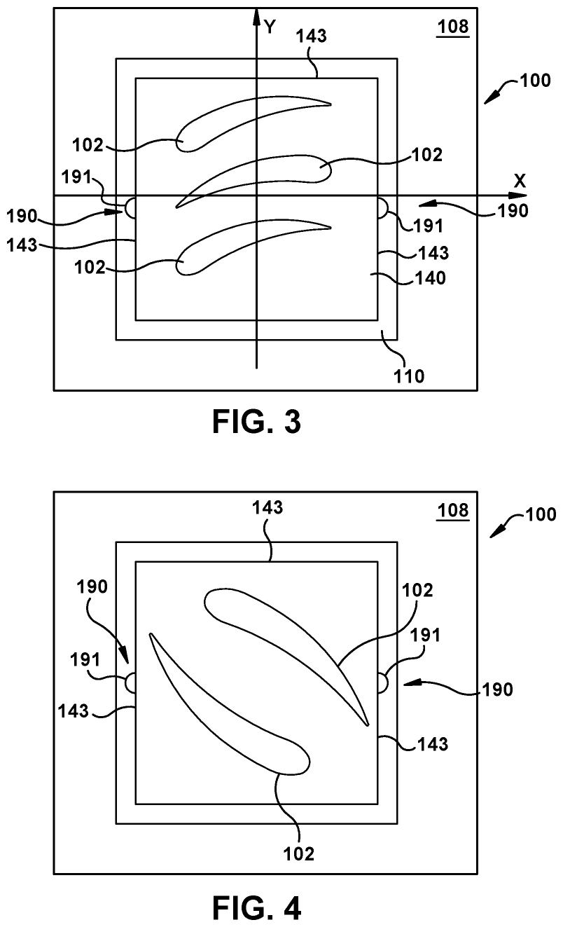

In use, as shown in FIGS. 1 and 3, object(s) 102 are built on build platform 104 using any additive manufacture process, for example, but not limited to, DED or other additive manufacturing system or process. Base 110 directly contacts build platform 104. As shown in FIG. 1, where object(s) 102 do not exert sufficient force on build platform 104 to flex, build platform 104 remains substantially coplanar with base 110. However, where object(s) 102 exert sufficient force (F) on build platform 104 to flex, build platform 104 may flex in peripheral regions(s) 142, and can come out of direct contact with base 110. However, middle region 140 of build platform 104 may remain in direct contact with base 110 retaining a substantially coplanar relationship with base 110 because object 102 provides adequate weight on build platform 104 to maintain middle region 140 of build platform 104 in contact with base 110.

The force necessary to cause the flexing and the location of the force can be customized to address any challenge, e.g., crack-prone objects 102, build platform-base connection breakage, etc. More particularly, the location, shape, size and/or number of middle regions 140 and periphery 143 of peripheral region 142 can be adjusted to address build challenges, depending on a number of factors. For example, as shown in FIG. 2, an object 102 to be built may have a dimension (D). In the example illustrated in FIGS. 2 and 3, periphery 143 of peripheral region 142 is positioned under outer ends 148 of object 102.

Where crack-prone material is being used for object 102, a larger peripheral region 142 or a larger number of peripheral regions 142 may be desirable. In the examples shown in FIG. 2, middle region 140 extends an entire length (L) of build platform 104, and two lengthwise (L) peripheral region 142 flank the middle region 140. Here, periphery 143 of peripheral region 142 includes first opposing peripheral sides 142A, 142B positioned across a Y axis of build platform 104.

As shown in the plan views of FIGS. 3-5, the location, shape, size and/or number of middle region 140 and/or periphery 143 of peripheral region 142 can vary in a wide variety of ways. In the FIG. 3 example, middle region 140 is centered widthwise (W) and lengthwise (L) on build platform 104 with one surrounding periphery 143 of peripheral region 142. Here, periphery 143 of peripheral region 142 includes first opposing peripheral sides positioned across a Y-axis of build platform 104, and second opposing peripheral sides positioned across an X axis of build platform 104. In the FIG. 4 example, middle region 140 extends diagonally on build platform 104 with periphery 143 of peripheral region 142 having two sides on either side of middle region 140. While particular examples of middle region(s) 140 and peripheral region(s) 142 arrangements have been provided, it is emphasized that a wide variety of arrangements are possible.

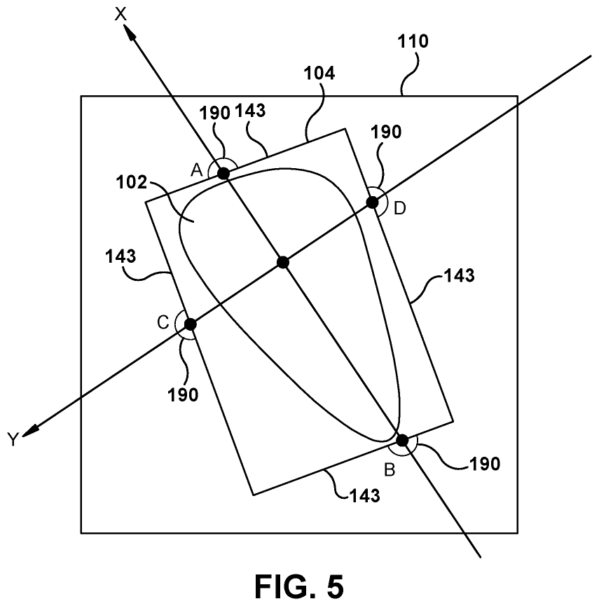

In FIG. 5, build platform 104 is configured and connected to base 110 to relieve stress and constraint imposed by base 110 on object 102. Thus, the configuration of build platform 104 and base 110 can enhance reduction of thermal cracking risk by mitigating thermal shrinkage of object 102. Thus, as embodied by one aspect of the disclosure, one location to fix build platform 104 to base 110 can be at a region close to a centroid, defined by axes X and Y of a base of object 102 as illustrated in FIG. 5. This location of the centroid may be at an interior of an interface between build platform 104 and base 110. Accordingly, in a further aspect of the embodiments, a further effective way of fixing build platform 104 to base 110 is to provide metallurgical connection 190, and conduct welding, clamping, or bolting in proximity to an intersection between an edge and principal axis of build platform 104. This intersection on build platform 104 can correspond to a largest moment of inertia of the base area of object 102, which are illustrated at points C and D in FIG. 5).

Due to the thermal deformation of object 102 during an additive manufacturing process, the build platform 104 may experience moderate upward deflection with respect to base 110 in additive manufacturing processing. Such a deflection is often not significant enough to be able to affect the additive manufacturing process. As embodied by the disclosure, restricting upward deflection of build platform 104 with respect to base 110, metallurgical connection 190 (as one or more separation restrictors) can be added at regions of build platform 104 to limit separation from base 110. In certain aspects of the embodiments of the disclosure, such locations may be proximate points A or B in FIG. 5. Points A and B are located proximate edges of the build platform 104 at intersections with principal axis X, which corresponds to a minimum moment of inertia of a base of object 102.

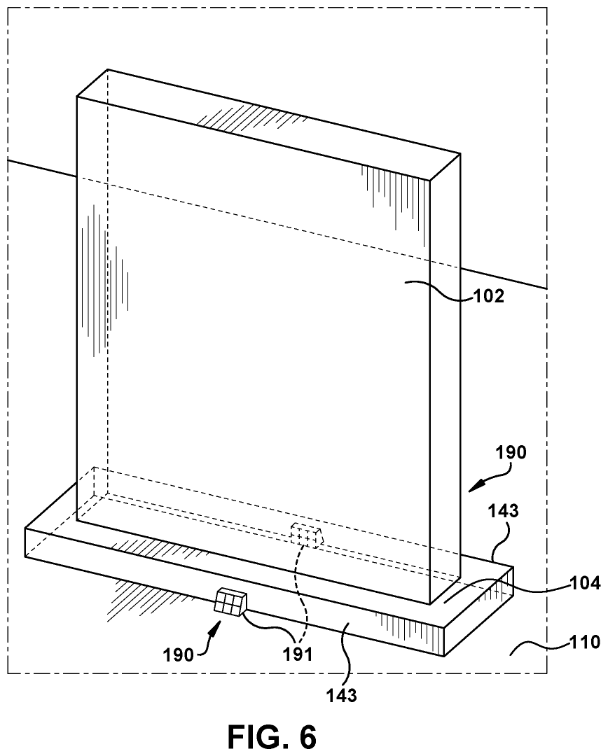

FIG. 6 depicts a case in which the base shape of object 102 is rectangular. According to the aforementioned method, the mid-points of the long edges of the build platform 104 can be fixed to remove rigid body motion of base 110 and to eliminate thermal cracking from flexing in object 102. According to certain aspects of the embodiments, mid-points of long edges of build platform 104 can be fixed to base 110. Fixing of build platform 104 with respect to base 110 can reduce or eliminate motion of build platform 104 with respect to base 110. Alternately or in addition thereto, fixing of build platform 104 with respect to base 110 can reduce or eliminate thermal cracking in object 102. Build platform 104 can be fixed to base 110 at two or more locations by metallurgical connection 190, for example but not limited to, by welding.

Thus, in embodiments of FIGS. 1-6, peripheral region(s) 142 are not allowed to flex to any extent by metallurgical connection 190 between build platform 104 and base 110.

Embodiments of the disclosure may also include a method of additively manufacturing an object by AM system 100, as described herein.

FIG. 7 shows a schematic block diagram of an example AM system 100. AM system 100 in FIG. 7 generally includes a metal powder additive manufacturing control system 200 (“control system”) and an AM printer 202. Control system 200 executes object code 204O to generate object(s) 102 using one or more melting beam sources, e.g., lasers 124. The teachings of the disclosure are applicable to any melting beam source, e.g., an electron beam, laser, etc. Control system 200 is shown implemented on a computer 206 as computer program code. To this extent, computer 206 is shown including a memory 208 and/or a storage system 210, a processor unit (PU) 212, an input/output (I/O) interface 214, and a bus 216. Further, computer 206 is shown in communication with an external I/O device/resource 220 and storage system 210. In general, processor unit (PU) 212 executes computer program code 204 that is stored in memory 208 and/or storage system 210. While executing computer program code 204, processor unit (PU) 212 can read and/or write data to/from memory 208, storage system 210, I/O device 220 and/or AM printer 202. Bus 216 provides a communication link between each of the objects in computer 206, and I/O device 220 can comprise any device that enables a user to interact with computer 206 (e.g., keyboard, pointing device, display, etc.). Computer 206 is only representative of various possible combinations of hardware and software. For example, processor unit (PU) 212 may comprise a single processing unit or be distributed across one or more processing units in one or more locations, e.g., on a client and server. Similarly, memory 208 and/or storage system 210 may reside at one or more physical locations. Memory 208 and/or storage system 210 can comprise any combination of various types of non-transitory computer readable storage medium including magnetic media, optical media, random access memory (RAM), read only memory (ROM), etc. Computer 206 can comprise any type of computing device such as an industrial controller, a network server, a desktop computer, a laptop, a handheld device, etc.

As noted, AM system 100 and, in particular control system 200, executes program code 204 to generate object(s) 102, and in certain aspects of the embodiment, program code 204 may include code to generate the at least one metallurgical connection 190 between build platform 104 and base 110. System 100 and program code 204 instructs applicator 120 to create the at least one metallurgical connection 190 between build platform 104 and base 110. Creation of the at least one metallurgical connection 190 between build platform 104 and base 110 can occur before the start of the additive manufacturing of object 102. The at least one metallurgical connection 190 between build platform 104 and base 110 can be created by applicator 120 during steps of additive manufacturing of object 102, but before any flexing of build platform 104 occurs and/or stress occurs in object 102 from being additive manufactured.

Program code 204 can include, among other things, a set of computer-executable instructions (herein referred to as ‘system code 204S’) for operating AM printer 202 or other system parts, and a set of computer-executable instructions (herein referred to as ‘object code 204O’) defining object(s) 102 to be physically generated by AM printer 202. As described herein, the additive manufacturing methods begin with a non-transitory computer readable storage medium (e.g., memory 208, storage system 210, etc.) storing program code 204. System code 204S for operating AM printer 202 may include any now known or later developed software code capable of operating AM printer 202.

Object code 204O defining object(s) 102 may include a precisely defined 3D model of an object and can be generated from any of a large variety of well-known computer aided design (CAD) software systems such as AutoCAD®, TurboCAD®, DesignCAD 3D Max, etc. In this regard, object code 204O can include any now known or later developed file format. Furthermore, object code 204O representative of object(s) 102 may be translated between different formats. For example, object code 204O may include Standard Tessellation Language (STL) files which was created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional object to be fabricated on any AM printer. Object code 204O representative of object(s) 102 may also be converted into a set of data signals and transmitted, received as a set of data signals and converted to code, stored, etc., as necessary. In any event, object code 204O may be an input to AM system 100 and may come from a part designer, an intellectual property (IP) provider, a design company, the operator, or owner of AM system 100, or from other sources. In any event, control system 200 executes system code 204S and object code 204O, dividing object(s) 102 into a series of thin slices that assembles using AM printer 202 in successive layers of material.

One or more melting beam sources, e.g., lasers 124, are configured to melt layers of metal powder on build platform 104 to generate object(s) 102.

Continuing with FIG. 7, applicator 120 can create the at least one metallurgical connection 190 between build platform 104 and base 110. Creation of the at least one metallurgical connection 190 between build platform 104 and base 110 can occur before the start of the additive manufacturing of object 102. The at least one metallurgical connection 190 between build platform 104 and base 110 can be created by applicator 120 during steps of additive manufacturing of object 102, but before any flexing of build platform 104 occurs and/or stress occurs in object 102 from being additive manufactured.

Also, applicator 120 may create a thin layer of raw material 122 spread out as the blank canvas from which each successive slice of the final object will be created. Applicator 120 may move under control of a linear transport system 230. Linear transport system 230 may include any now known or later developed arrangement for moving applicator 120. In one embodiment, linear transport system 230 may include a pair of opposing rails 232, 234 extending on opposing sides of build platform 104, and a linear actuator 236 such as an electric motor coupled to applicator 120 for moving it along rails 232, 234. Linear actuator 236 is controlled by control system 200 to move applicator 120. Other forms of linear transport systems may also be employed.

Applicator 120 take a variety of forms. In one embodiment, applicator 120 may include a body 238 configured to move along opposing rails 232, 234, and an actuator element (not shown in FIG. 7) in the form of a tip, blade or brush configured to spread metal powder evenly over build platform 104, i.e., build platform 104 or a previously formed layer of object(s) 102, to create a layer of raw material. The actuator element may be coupled to body 238 using a holder (not shown) in any number of ways. The process may use different raw materials in the form of metal powder. Raw materials may be provided to applicator 120 in a number of ways. In one embodiment, shown in FIG. 7, a stock of raw material may be held in a raw material source 240 in the form of a chamber accessible by applicator 120. In other arrangements, raw material 122 may be delivered through applicator 120, e.g., through body 238 in front of its applicator element and over build platform 104. In any event, an overflow chamber 241 may be provided on a far side of applicator 120 to capture any overflow of raw material not layered on build platform 104.

In one embodiment, object(s) 102 may be made of a metal which may include a pure metal or an alloy. In one example, the metal may include practically any non-reactive metal powder, i.e., non-explosive or non-conductive powder, such as but not limited to: a cobalt chromium molybdenum (CoCrMo) alloy, stainless steel, an austenite nickel-chromium based alloy such as a nickel-chromium-molybdenum-niobium alloy (NiCrMoNb) (e.g., Inconel 625 or Inconel 718), a nickel-chromium-iron-molybdenum alloy (NiCrFeMo) (e.g., Hastelloy® X available from Haynes International, Inc.), or a nickel-chromium-cobalt-molybdenum alloy (NiCrCoMo) (e.g., Haynes 282 available from Haynes International, Inc.), etc. In another example, the metal may include practically any metal such as but not limited to tool steel (e.g., H13), titanium alloy (e.g., Ti₆Al₄V), stainless steel (e.g., 316L) cobalt-chrome alloy (e.g., CoCrMo), and aluminum alloy (e.g., AlSiioMg).

The atmosphere within build chamber 108 may be controlled for the particular type of additive manufacturing and/or melting beam source being used. For example, for lasers 124, build chamber 108 may be filled with an inert gas such as argon or nitrogen and controlled to minimize or eliminate oxygen. Here, control system 200 is configured to control a flow of an inert gas mixture 242 within build chamber 108 (if provided) from a source of inert gas 244. In this case, control system 200 may control a pump 246, and/or a flow valve system 248 for inert gas to control the content of gas mixture 242. Flow valve system 248 may include one or more computer controllable valves, flow sensors, temperature sensors, pressure sensors, etc., capable of precisely controlling flow of the particular gas. Pump 246 may be provided with or without valve system 248. Where pump 246 is omitted, inert gas may simply enter a conduit or manifold prior to introduction to build chamber 108. Source of inert gas 244 may take the form of any conventional source for the material contained therein, e.g., a tank, reservoir, or other source.

Any sensors (not shown) required to measure gas mixture 242 may be provided. Gas mixture 242 may be filtered using a filter 250 in a conventional manner. Alternatively, for electron beams, build chamber 108 may be controlled to maintain a vacuum. Here, control system 200 may control a pump 246 to maintain the vacuum, and flow valve system 248, source of inert gas 244 and/or filter 250 may be omitted. Any sensors (not shown) necessary to maintain the vacuum may be employed.

Adjustment system 134 may be provided to adjust a position of various parts of AM printer 202 to accommodate the addition of each new layer, e.g., a build platform 104 may lower and/or chamber 108 and/or applicator 120 may rise after each layer. Adjustment system may provide vertical adjustment, horizontal adjustment, a combination of vertical and horizontal adjustment, and rotational adjustment with vertical adjustment, horizontal adjustment, and/or a combination of vertical and horizontal. Adjustment system 134 may include any now known or later developed linear actuators to provide such adjustment that are under the control of control system 200.

In operation, build platform 104 with metal powder thereon is provided within build chamber 108 (if provided, as discussed above), and control system 200 controls the atmosphere within build chamber 108. Control system 200 also controls AM printer 202, and in particular, applicator 120 (e.g., linear actuator 236) and melting beam source(s) (e.g., laser(s) 124) to sequentially melt layers of metal powder on build platform 104 to generate object(s) 102 according to embodiments of the disclosure.

As noted, various parts of AM printer 202 may vertically move via adjustment system 134 to accommodate the addition of each new layer, e.g., a build platform 104 may lower, and/or chamber 108 and/or applicator 120 may rise after each layer. Where object(s) 102 tend to exert force F on peripheral region(s) 142 of build platform 104 (FIG. 1), peripheral region(s) 142 of build platform 104 are restrained from upwardly flexing by metallurgical connection 190 configured for fixedly and rigidly coupling periphery 143 of peripheral region 142 to base 110. Meanwhile, middle region 140 remains in direct contact with base 110, due in part to the weight of object 102 on the build platform. While a particular AM system has been described herein, it is emphasized that the teachings of the disclosure are applicable to a wide variety of additive manufacturing processes other than DMLM.

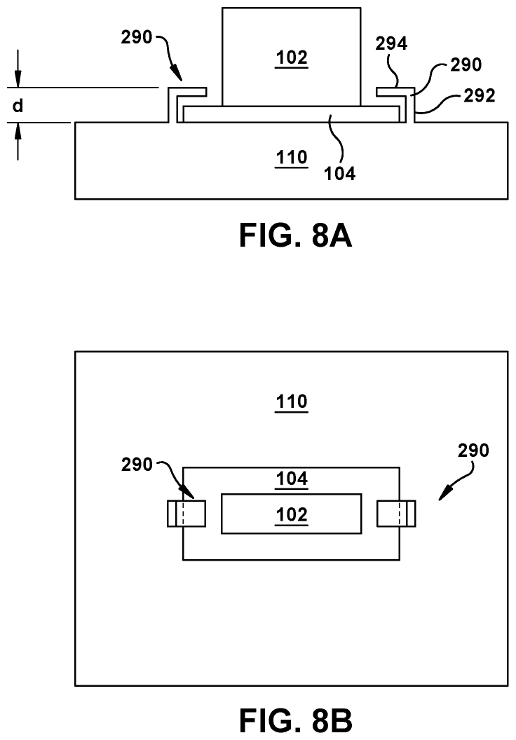

Embodiments of AM system 100 allow development of large additive objects that may have high thermal stress during the additive manufacturing processes and may normally crack by reducing the stress therein, thus improving producibility and/or part yield. The system, as embodied by the disclosure, also allows production of larger additively manufactured objects, perhaps with more crack prone material(s). Any flex limiter provided is located in a protected manner within the build platform, i.e., not above or below the build platform, or between the build platform and the base. The build platform 104 and/or base 110 for AM system 100 in FIGS. 8-11 provide flex limiting and restricting features that reduce stress in an additively manufactured object 102, thus may enhance producibility and/or part yield by reducing the stress therein.

As embodied by the disclosure, metallurgical connection 190 can be provided for restricting upward deflection and/or separation of build platform 104 with respect to base 110. In further aspects of embodiments of the disclosure, one or more separation restrictors can be added at regions of build platform 104 to restrict deflection and/or separation of build platform 104 with respect to base 110.

FIGS. 8A and 8B illustrate schematic views of a front view and a top view of separation restrictor(s) 290. In one aspect of the embodiments, separation restrictors 290 are incorporated with base 110. Separation restrictor 290 includes a first leg 292 that extends a first distance d from base 110. Distance d is greater than a height of build platform 104. Separation restrictor 290 also includes a second leg 294 that extends from first leg 292, parallel to base 110 and over build platform 104. Thus, if build platform 104 flexes, deflects, and/or separates from base 110 during additive manufacturing processing, second leg 294 will restrict flexing, deflection and/or separation of build platform 104 with respect to base 110.

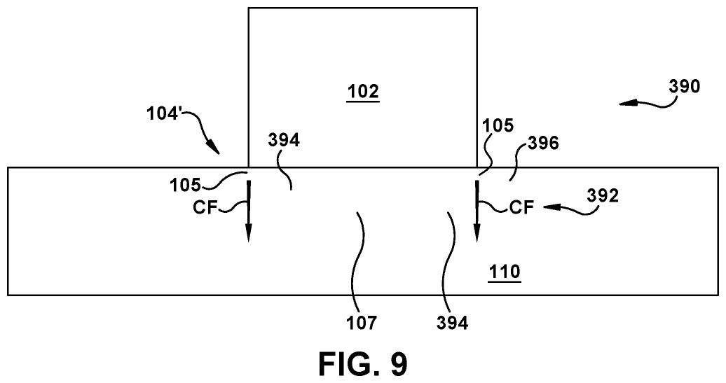

FIG. 9 illustrates a schematic front view of an alternate embodiment of the flexible base with a restrictor configuration 390 to limit separation. Restrictor configuration 390 can be incorporated to restrict deflection and/or separation of build platform 104 with respect to base 110. Separation restrictor 390 includes at least one slot 392 formed into base 110, thus creating build platform 104′. At least one slot 392 may be cut into base 110 so rigidity of base 110 is reduced. Accordingly, crack-inducing over-constraint on object 102 is substantially mitigated during fabrication buy at least one slot 392 deflecting as described herein.

At least one slot 392 includes a first slot 394 and a second slot 396. First slot 304 extends from under object 102 being formed by additive manufacturing generally parallel to base 110. Second slot 396 extends from first slot 394 to a surface of base 110 upon which object 102 is being built. Accordingly, as embodied by this aspect of the disclosure, first slot 394 and second slot 396 combine to create build platform 104′ from base 110. Build platform 104′ thus includes cantilevered portions 105 extending from a central support portion 107. The configuration of FIG. 9 with build platform 104′ including cantilevered portions 105 and central support portion 107 may enable flexing of build platform 104′ by a mass of object 102 in “downward” direction CF opposite to deflection caused by force F (FIG. 1) caused by additive manufacturing. Thus, in accordance with this aspect of the embodiments, a flex limiting and restricting configuration of FIG. 9, may avoid or reduce stress in object 102.

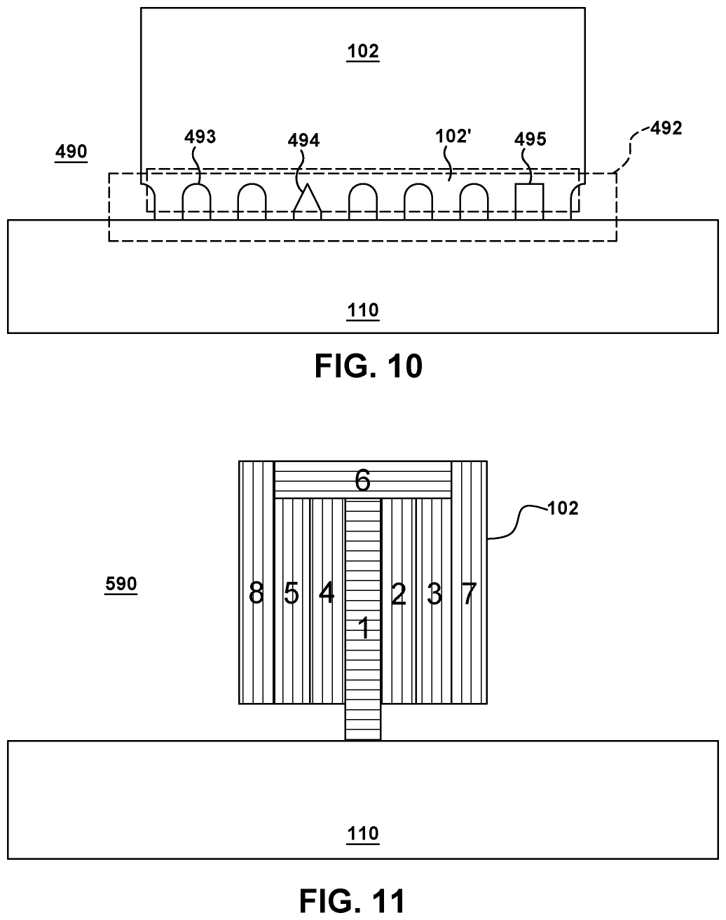

As illustrated in FIG. 10, object 102 can be formed with reduced interface area 492 between object 102 and an underlying portion of base 110. As embodied by the disclosure, FIG. 10 illustrates a further alternate embodiment of the flexible base with a restrictor configuration 490 to limit separation. Restrictor configuration 490 can be incorporated into object 102 during additive manufacturing to restrict deflection and/or separation with respect to base 110. In accordance with FIG. 10, control system 200 executes object code 204O (FIG. 7) to generate object(s) 102 with a base 102′ of object 102 having a reduced solid connection at reduced interface area 492. In a certain non-limiting aspect of the embodiments, base 102 of object 102 can be formed in any programmable shape to provide reduced solid connection areas. In certain aspects, reduced solid connection area 492 can be uniformly shaped. Reduced solid connection area 492 can include diverse configurations. For example, and not intending to limit the embodiments, reduced solid connection area 492 in object 102 can include arched or curved voids, triangular reduced solid connection area 494, polygonal reduced solid connection area 495, and/or other configurations of reduced solid connection areas now known or hereinafter developed.

Another and further approach for additively manufacturing object 102 and for restricting flexing, deflection, and/or separation of object 102 with respect to base 110 is illustrated in FIG. 11. As illustrated in FIG. 11, fabrication of object 102 includes sequential formation of object 102. A first fabrication step is to additively manufacture a vertical, slender portion 1 of object 102 on base 110. With respect to FIG. 11, control system 200 executes object code 204O (FIG. 7) to generate portions (1-8, FIG. 11). Control system 200 executes object code 204O (see FIG. 7) to rotate base 110 by 90° or 180°. Fabrication of object 102 continues by sequentially additively manufacturing and depositing material on lateral surfaces of vertical, slender portion 1.

In FIG. 11, numbers on portions of object 102 denote the fabrication sequence of corresponding portions of object 102. As illustrated, portions of object 102 in FIG. 11 are on opposite sides of vertical, slender portion 1. Thus, rotation of 180° of base 110 occurs after each portion (1-5) of object 102 is deposited on desired portion to create object 102. Further, as directed by object code 204O, portion 6 may be added after a rotation of 90° of base 110 to enable a desired structure of object 102.

This additively manufacturing process of FIG. 11 can provide relief of crack-inducing over-constraint between base 110 and object 102 as the single vertical, slender portion 1 of object 102 in contact with base 110. As embodied by the disclosure, object 102 can be formed in multiple configurations enabled by the additively manufacturing process. Further, the additively manufacturing process of FIG. 11 exploits advantages of DED AM. For example, the DED AM additively manufacturing process enables rotation of base 110 during additively manufacturing. Other additively manufacturing processes, such as but not limited to powder-bed additively manufacturing, are difficult or impossible to enable rotation of an additively manufacturing system, including a build plate or base.

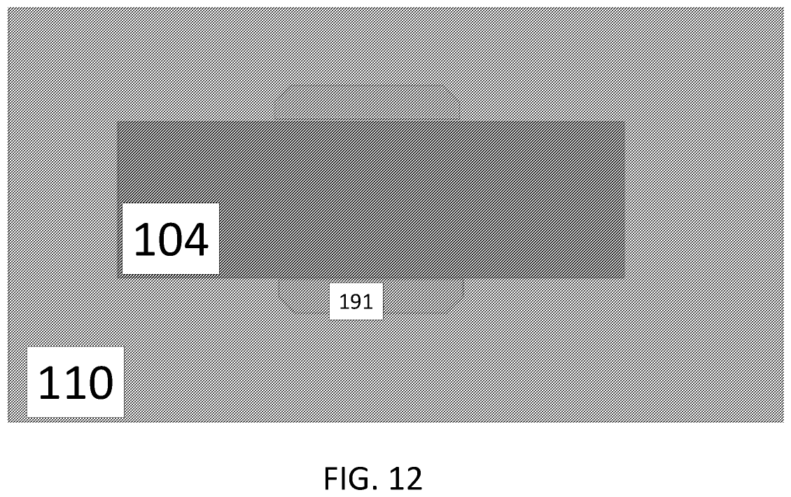

FIG. 12 illustrates a block diagram of a rectangular additively manufactured object on a build platform and base with an elongated metallurgical connection between the build platform and base, according to embodiments of the disclosure. In FIG. 12, the base shape of object 102 is rectangular. According to the aforementioned method, the mid-points of the long edges of the build platform 104 should be fixed to remove rigid body motion of base 110 and to eliminate thermal cracking from flexing in object 102. According to certain aspects of the embodiments, mid-points of long edges of build platform 104 can be fixed to base 110. Build platform 104 can be fixed to base 110 at two or more locations by an elongated metallurgical connection 190, for example but not limited to, by welding. Fixing of build platform 104 with respect to base 110 can reduce or eliminate motion of build platform 104 with respect to base 110. Alternately or in addition thereto, fixing of build platform 104 with respect to base 110 can reduce or eliminate thermal cracking in object 102.

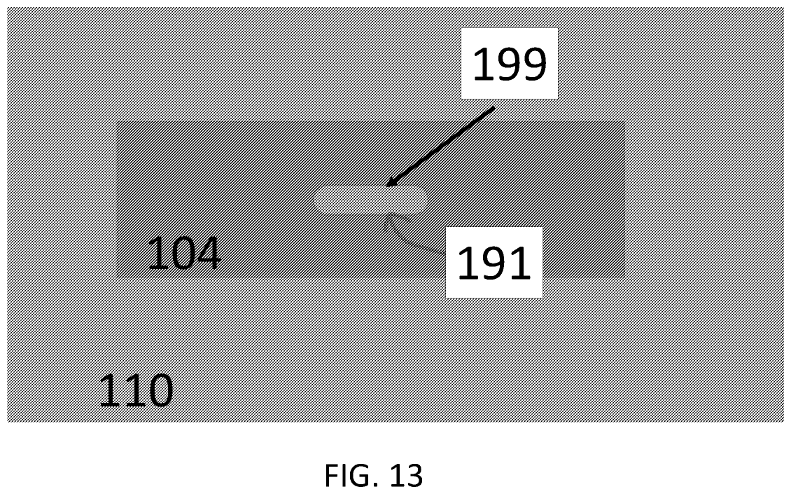

FIG. 13 illustrates a further block diagram of a rectangular additively manufactured object on a build platform and base with a metallurgical connection disposed beneath and between the build platform and base, according to embodiments of the disclosure. In FIG. 13, the base shape of object 102 is rectangular. According to the aforementioned method, the mid-points of the long edges of the build platform 104 should be fixed to remove rigid body motion of base 110 and to eliminate thermal cracking from flexing in object 102. According to the FIG. 13 aspect of the embodiments, a slot 199 can be formed in build platform 104. The slot 199 is illustrated in FIG. 13 as centrally located on build platform 104. However, as embodied by the disclosure, slot 199 can be located at any location in build platform 104 where weld 191 can retain and fix object 102 to build platform 104 to reduce or eliminate motion.

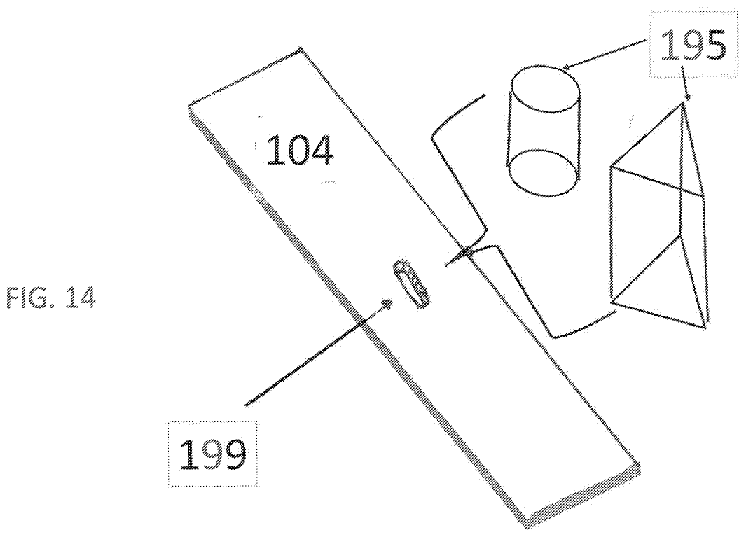

FIG. 14 illustrates a block diagram of a rectangular additively manufactured object on a build platform and base with a metallurgical connection between the build platform and base, according to embodiments of the disclosure. FIG. 14 depicts a case in which the base shape of object 102 is rectangular. According to the aforementioned method, the mid-points of the long edges of the build platform 104 can be fixed to remove rigid body motion of base 110 and to eliminate thermal cracking from flexing in object 102. According to certain aspects of the embodiments, in FIG. 14 aspect of the embodiments, a slot 199 can be formed in build platform 104. The slot 199 is illustrated in FIG. 14 as centrally located on build platform 104. However, as embodied by the disclosure, slot 199 can be located at any location in build platform 104. As embodied by the disclosure, the embodiment of FIG. 14 includes at least one peg or protrusion 195 positioned on build platform 104. The at least one protrusion 195 is configured in a shape and orientation to prevent rotation of object 102 on build platform 104 as object 102 is formed and undergoes any thermal distortion in the additive manufacturing process.

With respect to FIG. 14, at least one protrusion 195 can be disposed on the build platform 104 and object 102 can be additively manufactured around the at least one protrusion 195. In accordance with another aspect of the disclosures, the at least one protrusion 195 can be positioned in a slot 199 provided in build platform 104. In accordance with another aspect of the disclosure, the at least one protrusion 195 can be formed by the additive manufacturing process before formation of the object. Alternately, the at least one protrusion 195 can be formed separately from the additive manufacturing process of the embodiments and attached to the build platform 104.

In FIG. 14, the at least one protrusion 195 is illustrated as an ellipsoid and a polygon (triangular) peg or protrusion. These configurations would prevent rotation of the object 102 with respect to build platform 104. As embodied by the disclosure, the at least one protrusion 195 as a polygon can be formed as any polygon with any number of sides.

With respect to protrusion 195, more than one protrusion 195 can be provided to prevent rotation of object 102 on build platform 104 as object 102 is formed and undergoes any thermal distortion in the additive manufacturing process. Where multiple protrusions 195 are provided, the protrusion 195 can be formed as a circular protrusion, as the two or more circular protrusions will prevent rotation of the object 102 with respect to build platform 104.

The foregoing drawings show some of the processing associated according to several embodiments of this disclosure. The acts noted in the drawings or description may occur out of the order noted or, for example, may in fact be executed substantially concurrently or in the reverse order, depending upon the act involved. Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately,” as applied to a particular value of a range, applies to both end values and, unless otherwise dependent on the precision of the instrument measuring the value, may indicate +/−5% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

1. An additive manufacturing (AM) system, comprising:
an adjustable base;
a build platform including a peripheral region and a periphery of the peripheral region, the periphery being fixedly and rigidly coupled to the base and a middle region, wherein a metallurgical connection fixedly and rigidly couples the periphery of the peripheral region to the base; and
a build material applicator for depositing a build material above the build platform for creating an object.

2. The AM system of claim 1, wherein the metallurgical connection includes at least one of a weld, solder, braze, or solid-state connection for fixedly and rigidly coupling the periphery of the peripheral region to the base.

3. The AM system of claim 1, wherein the metallurgical connection includes at least one weld for fixedly and rigidly coupling the periphery of the peripheral region to the base.

4. The AM system of claim 3, wherein the at least one weld includes at least one of a fusion weld, a tack weld, a metal inert gas (MIG) weld, a gas metal arc weld (GMAW), a tungsten inert gas (TIG) weld, a stick-shielded metal arc weld (SMAW), a flux-cored-flux weld, an energy beam weld (EBW), an atomic hydrogen weld (AHW), a plasma arc weld, and combinations thereof, for fixedly and rigidly coupling the periphery of the peripheral region to the base.

5. The AM system of claim 3, wherein the at least one weld includes a tack weld.

6. The AM system of claim 1, wherein the metallurgical connection is provided by the build material applicator for fixedly and rigidly coupling the periphery of the peripheral region to the base.

7. The AM system of claim 6, wherein the metallurgical connection includes the build material for fixedly and rigidly coupling the periphery of the peripheral region to the base.

8. The AM system of claim 1, wherein the base includes a first material, and the metallurgical connection includes the first material.

9. The AM system of claim 1, wherein the build material applicator for depositing a build material deposits the build material by at least one of direct metal laser melting, direct metal laser sintering, selective laser melting, and directed energy deposition.

10. The AM system of claim 1, wherein the periphery of the peripheral region includes first opposing peripheries across an X axis of the build platform and second opposing peripheries across a Y axis of the build platform, and the metallurgical connection is positioned on at least one of the X axis and the Y axis.

11. The AM system of claim 10, wherein the metallurgical connection is positioned on the X axis and the Y axis.

12. An additive manufacturing (AM) system, comprising:
an adjustable base;
a build platform including a peripheral region and a periphery of the peripheral region, the periphery being fixedly and rigidly coupled to the base by a metallurgical connection configured for fixedly and rigidly coupling the periphery of the peripheral region to the base; and
a build material applicator for depositing a build material above the build platform for creating an object.

13. The AM system of claim 12, wherein the metallurgical connection includes at least one of a weld, solder, braze, or solid-state connection for fixedly and rigidly coupling the periphery of the peripheral region to the base.

14. The AM system of claim 12, wherein the metallurgical connection includes at least one weld for fixedly and rigidly coupling the periphery of the peripheral region to the base.

15. The AM system of claim 14, wherein the at least one weld includes at least one of a fusion weld, a tack weld, a metal inert gas (MIG) weld, a gas metal arc weld (GMAW), a tungsten inert gas (TIG) weld), a stick-shielded metal arc weld (SMAW), a flux-cored-flux weld, an energy beam weld (EBW), an atomic hydrogen weld (AHW), and a plasma arc weld, for fixedly and rigidly coupling the periphery of the peripheral region to the base.

16. The AM system of claim 15, wherein the at least one weld includes a tack weld.

17. The AM system of claim 13, wherein the metallurgical connection is provided by the build material applicator for fixedly and rigidly coupling the periphery of the peripheral region to the base.

18. The AM system of claim 16, wherein the metallurgical connection includes the build material for fixedly and rigidly coupling the periphery of the peripheral region to the base.

19. The AM system of claim 13, wherein the base includes a first material and the metallurgical connection includes the first material.

20. The AM system of claim 12, wherein the peripheral region includes first opposing peripheries across an X axis of the build platform and a second opposing peripheries across a Y axis of the build platform, and the metallurgical connection is positioned on at least one of the X axis and the Y axis.
